(19) United States
(12) Patent Application Publication
(10) Pub. No.: US 2008/0105094 A1
(43) Pub. Date: May 8, 2008

(54) Machine and Control System

(75) Inventors: David Roberts McMurtry, Dursley (GB); Geoffrey McFarland, Wotton-Under-Edge (GB); Paul Maxted, Bristol (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge (GB)

(21) Appl. No.: 11/792,134

(22) PCT Filed: Dec. 20, 2005
(86) PCT No.: PCT/GB05/04890

§ 371 Date: Jun. 1, 2007

(30) Foreign Application Priority Data
Dec. 20, 2004 (GB) 0427796.8
Dec. 21, 2004 (GB) 0427964.2

(51) Int. Cl. B23B 9/08; B23B 1/00

(52) U.S. Cl. 82/118; 82/1.11

(57) ABSTRACT

A machine tool control method is disclosed employing a machine tool for carrying out a work producing process having a cutting implement for machining a workpiece according to the process, the cutting implement comprising a first part having a shank and a second part having a cutting surface and, optionally a tool holder, a sensor device provided on the second part of the cutting implement for sensing at least one condition of the process, and a machine controller, the method comprising: operating the machine under the control of the machine controller to cause a process to commence, sensing at least one condition of the process, and adapting controller or sensor based cutting parameters during the process in accordance with the sensed condition. The cutting implement may be changeable during the process. The process can be a single cutting operation. Sensor based parameters can be adapted independently of the machine controller.

This invention relates to a machine used to produce a workpiece e.g. by cutting of material and a system which controls such a machine.

Modern machine control is dominated by so-called computer numerical control. This system uses a program code which instructs the machine to move in various directions with respect to a workpiece to cut metal, together with further instructions e.g. spindle speed or starting of coolant flow etc. The program is loaded into the machine's controller commonly called an “NC” and run. It is possible to change variables in the program only by stopping the program and calling for those variables from elsewhere e.g. a separate pc.

Problems can occur during machining or other work producing operations on a machine which uses a rotating cutting implement or work forming device. For example, a cutting implement may cause vibration of the workpiece or machine bed which is not predictable. The point of onset of the vibration and its severity are highly variable. Severe vibration will cause unacceptable surface finish. Thermal changes also can cause work distortion and lead to inaccurate workpiece dimensions.

Presently no arrangement is known to the inventors which can satisfactorily overcome the above-mentioned problems. Presently it is possible to monitor vibration and/or temperature at the workpiece but there is no way of altering the machine's operation immediately. Instead, presently it is necessary to finish a program instruction line, call for new parameters e.g. speed and feed of the cutter, and then continue with the next line of program. It is known to carry out an emergency stop of a machining process or to alert an operator by sounding an alarm but, stopping the process causes down time and requires operator intervention to remove the cause of the alarm.

Additionally, where no problem exists it may be desirable to demand increased productivity from the machine tool. Likewise, it is not possible to provide such increases instantaneously i.e. in real time and it is somewhat dangerous to demand increased productivity without the ability to withdraw the demand immediately should problems of the type mentioned above occur. Such demands for increased productivity could be made iteratively.

The invention provides a machine tool control method employing a machine tool for carrying out a work producing process having a cutting implement for machining a workpiece according to the work producing process the cutting implement comprising a first part having a shank and a second part having a cutting surface; a sensor device provided on the second part of the cutting implement for sensing at least one condition of the work producing process; and a machine controller, the method comprising in any suitable order the steps of:
operating the machine under the control of the machine controller to cause a work producing process to commence;
sensing the at least one condition of the work producing process;
adapting cutting parameters during the work producing process in accordance with the sensed condition.

An advantage of the invention over the prior art is that cutting parameters are adapted during a work producing process thus, rather than stopping the process to change a cutting implement or allow investigation of the cause behind the process being stopped as is disclosed in the prior art, the present invention allows in process alteration of cutting parameters as conditions change, for example as a cutting implement wears. Such alteration is an incremental adjustment of the work producing process resulting in increased productivity and reduced machine down time compared with current methods.

A work producing process includes both a single cutting or machining operation and a number of discrete cutting or machining operations.

Often the second part of the cutting implement will also include a tool holder, for example when the cutting surface is provided as an insert. The tool holder is located between the cutting surface and the shank and the sensor is again provided on the second part of the cutting implement i.e. at the cutting surface or on the tool holder. The cutting surface is the part of the cutting implement which carries out the work producing process i.e. removes material from a workpiece. In a monoblock implement, the cutting surface is connected directly to a shank which is attached to the spindle on the machine tool. Other types of cutting implement have a tool holder section between the cutting surface, which may be an insert, and the shank separating these two features.

Preferably, the machine tool includes a feedback loop between the machine controller and the cutting implement enabling alteration of the workpiece producing process.

Preferably, the cutting implement is changeable and, advantageously may be changed automatically during a work producing process.

Preferably the sensed condition of the work producing process includes cutting forces (including acceleration). The alteration or adaptation of the work producing process includes modification of the position of the cutting implement relative to the workpiece.

The invention extends to a machine tool controller for use with the method above.

The invention further extends to a machine tool controller operable according to the following method steps:
loading a work producing process program;
running the program to control the machine including rotating a spindle at a preselected rotational speed and causing relative movement of a preselected vector quantity between the spindle of the machine tool and a workpiece or cutting implement;
providing feedback to the controller relating to machining conditions;
characterised by the step of:
altering the rotational speed of the spindle or the vector quantity of the spindle relative to the workpiece or cutting implement during the work producing process and in accordance with the conditions communicated to the controller.

If the machine is a milling machine, then the relative movement is between the spindle and a workpiece. If the machine is a lathe, then the relative movement is between the spindle and a cutting implement.

Preferably the machine tool controller is capable of adaptive control by continually (e.g. every millisecond) monitoring at least one input indicative of the said condition whilst control of the work producing process is underway and updating the work producing process substantially in real time when required.

In addition to at least one sensor being present on the second part of the cutting implement, additional sensors can be provided to monitor conditions at the workpiece or on the machine tool. For example if a characteristic is measured on the cutting implement and at the spindle then, under normal conditions, a correlation would be expected between these values e.g. if the characteristic of the spindle increases one would expect the characteristic of the cutting implement to increase too. An example of such related characteristics is cutting implement force and spindle torque. A deviation in this correlation may be indicative of a problem such as cutting implement damage, breakage or wear.

Preferably the at least one condition mentioned in the paragraphs above includes one or more of the following:
vibration amplitude, frequency or variations thereof of either the cutting implement, work or parts of the machine;
temperature of the cutting implement, workpiece chips/swarf, or workpiece;
torque or forces exerted on the spindle or individual teeth of a cutter;
stress or strain or variations thereof on part of the machine, the cutter or the workpiece;
changes in amplitude or frequency of an excited cutting implement;
changes in capacitance, electrical resistance, magnetostrictive or electrostrictive properties of the cutting implement;
deflection of the cutting implement; and
errors in machine tool performance.

Preferably the at least one condition is communicated to the machine controller via a path which runs from the cutting implement through the spindle of the machine to the controller. Preferably the path includes contacts at the spindle at the interface between the cutting implement and the machine tool and a rotatable link e.g. inductive, between the spindle and the fixed part of the machine.

Alternatively, the path comprises slip rings which are buried within the machine spindle which provide a power line across to the cutting implement. Or, the cutting implement may be provided with a battery, transmitter and a receiver and electromagnetic transmission is used between the cutting implement and a communicating transmitter and receiver located on or near the machine tool.

Preferably the at least one condition is sensed using a sensor which is mounted to the second part of the cutting implement. The cutting implement may be rotatable and the sensing of the condition may take place whilst the cutting implement is rotating and/or cutting.

It is advantageous to locate a sensor on the cutting implement as this gives more accurate sensor readings than a sensor which is remote from the cutting implement e.g. on the machine tool or workpiece. In addition, smaller changes in a parameter can be detected. The load path length between the machine and the cutting edge is not increased by such sensors which is advantageous as anything which causes a displacement of the cutting edge from the spindle reduces the rigidity of the system making the work producing process less accurate and less repeatable.

A further aspect of the invention provides cutting implements having in built or integral sensors for example, a strain gauge which is embedded, integrated or attached onto the surface of the implement.

Such in-built sensors may be provided as part of the cutting surface or tool holder. Preferably, the sensors are part of the cutting surface which can be replaced when worn or damaged. In this case, a power and signal path may be provided from and to the machine controller via electrical connections between the cutting surface ands its mounting on the cutting implement and the machine controller actuated via an inductive link, slip rings or electromagnetic transmission.

Alternatively, the in built sensors can optionally, change cutting parameters related to the cutting implement independently of the machine controller however, at least a power path would be required to facilitate this.

The invention will be further explained with the aid of the drawings, of which:

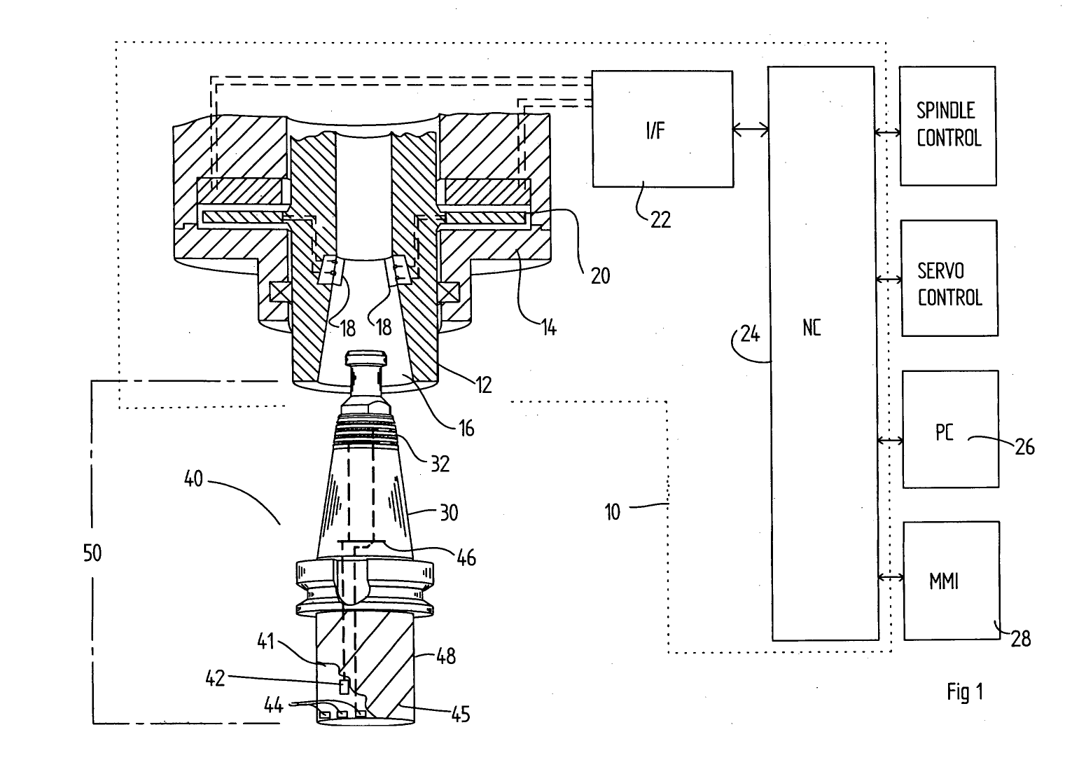

FIG. 1 shows elements of a CNC machine adapted for carrying out the method according to the invention;

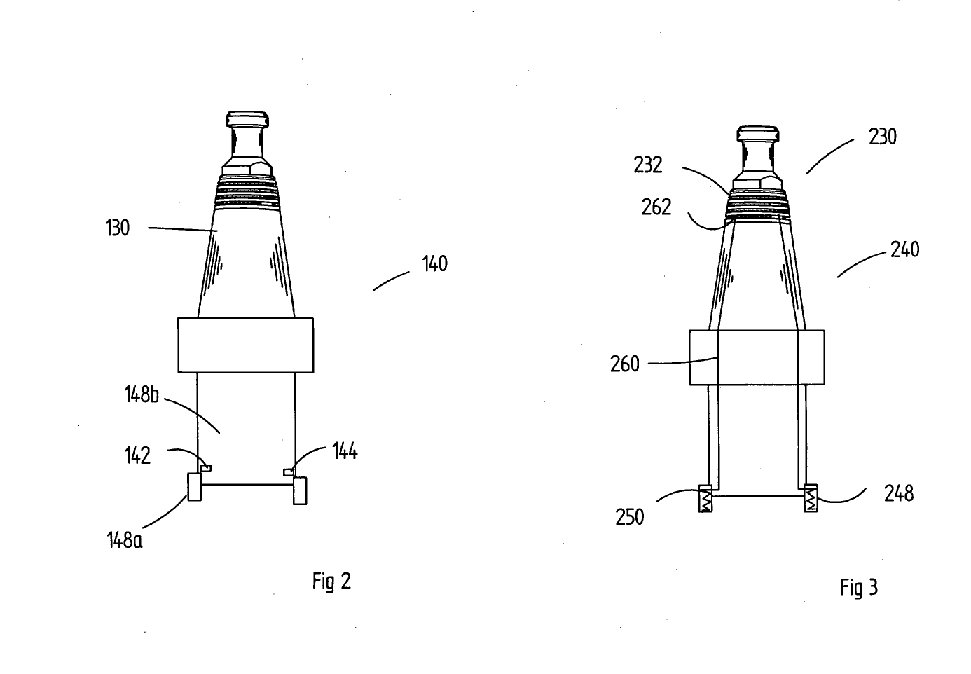

FIG. 2 shows a cutting implement according to the invention; and

FIG. 3 shows an alternative cutting implement according to the invention.

CNC machine tool 10 has a spindle 12 which is drivable by a motor (not shown). The machine tool has a fixed part 14 which does not rotate relative to the spindle. The spindle is rotated, usually with a cutting implement 40 mounted in cutting implement receiving area 16. The cutting implement 40 has a first part or shank 30 for fitting into the complementary cutting implement receiving area 16.

The load path length 50 is the distance between the cutting surfaces and the proximal end of the spindle when the cutting implement is attached to the spindle.

In this embodiment a second part of the cutting implement or cutting surface 48 has sensors 42 and 44 shown in partial cut away section 41. Sensor 42 is an accelerometer for measuring vibration and sensors 44 are temperature sensors for measuring the temperature close to the teeth 45 of the cutting implement. The sensors are connected via intermediate circuitry 46 to contacts 32. In use the shank 30 is positioned in area 16 and the contacts 32 abut complementary contacts 18 at the spindle 12.

In operation of the machine 10 signals from the sensors 42/44 pass across the contacts 32/18 to an inductive link 20 and then to an external interface 22. In this embodiment, the signals are then fed to NC 24. Alternatively, the signals can be processed by the interface 22 although usually, the motion of the spindle is controlled by the interface using instructions from the NC and the sensor data is processed by the NC which, after processing said data, communicates necessary changes to the spindle motion to the interface.

The NC 24 operates in a novel manner to monitor inputs from the interface 22 substantially continuously. In practice the NC executes conventional lines of program language but monitors the inputs from the interface every millisecond. An algorithm is run in the NC continuously and the inputs evaluated.

The inputs are processed such that a specific input triggers a modification in the line of program being executed at that time. This modification may alter the parameters set before the line of program commenced. In this case excessive cutting implement temperature or vibration causes a slowing of the feed rate or cutting speed of the cutting implement during the program line being executed. It is possible that too low a temperature or vibration causes an increase in feed rate or cutting implement cutting speed. Thus, the machining program is altered in real time.

In addition the inputs may be further pre-processed (either the NC 24, the interface 22, in a pc 26, or by operator intervention at MMI 28) such that optimum work production parameters may be obtained. For example, if it is known that certain conditions cause certain ill effects e.g. the workpiece naturally vibrates at a certain frequency, then if those conditions are about to be reached then the program for the work producing process can be modified predictively.

When the controller response is considered to be in real time, it generally means that the response occurs in 10 mS or less. For example, a transducer is provided to measure milling tool deflection during interpolation and the tool deflection is monitored, processed and the result applied to the machine controller path in real time. The tool tip path is therefore modified from the predetermined path during the milling process thus, the desired cut geometry is produced. The requirement to stop the process and modify the machine program to change cutting parameters to get a good part is removed.

Alternatively, the controller monitors inputs from the interface either at regular intervals or at predetermined points in the machining part program. So, although not substantially in real time, in this embodiment of the invention, adaptation of cutting parameters still occurs during a machining process. In this case, data is collected and processed in the interface. At the predetermined time or point in the part program, the controller checks process values from the interface, compares them to expected values and executes subsequent action to correct for any deviation in the process from the expected. For example, when a transducer is used to measure tool deflection during interpolation, the interface calculates and stores the feature position or size error. At the predetermined point in the program, for example the subsequent line of the part program, either the feature size is compared to expected feature size and the error calculated or the error value is read; the error is checked against a tolerance and if outside the tolerance, a macro is executed to re-machine the feature with a new path command to produce a feature of the correct size.

Thus the parameters: cutting implement feed rate; cutting implement speed; and cutting implement/work paths can be updated in real time irrespective of the program line running at the time.

The controller could also be used to modify parameters during operation based on historical data from sensors or other inputs. It is not presently possible to correct the form of a path of a cutter (e.g. circular path) so, whilst the centre and radius of such a path can be altered, if the machine tool cuts the circular path inaccurately an inaccurate form will be produced. The controller of the present invention can operate to accept input during cutting operations to correct geometrical errors by modification of the cutting implement path. The sensed condition in this instance will be stored data relating to the machine tool accuracy and the corrective paths required to produce an accurate workpiece, given inherent machine tool inaccuracies.

FIG. 2 shows a cutting implement 140, having a first part or shank 130 and a second part 148 which includes a cutting surface 148a (which is a cutting insert) and a tool holder 148b. Sensors 142 and 144 are provided adjacent or in proximity to the cutting surface 148a on the tool holder 148b.

In this example, the sensors 142,144 include one or more of the following: strain gauge; thermistor; thermocouple; piezoelectric element; capacitor; magnetostrictive element; electrostrictive element; optical transducer (PSD, encoder, camera); accelerometer; electrical circuit; microphone.

A number of different conditions or parameters can be measured by these sensors. For example, temperature which is proportional to the friction between the cutting implement and a workpiece and indicative of cutting surface wear by a thermistor; thermocouple; bimetallic strip; or infra red measurement.

Vibration or chatter which can cause a rough cut by the cutting implement can be measured by a piezoelectric element; internal optical transducer; strain gauge; or accelerometer. Vibration or imbalance of the spindle or spindle bearing can affect wear of machine parts such as bearings and can be measured using accelerometers.

Force on the cutting implement which, when excessive can cause the cutting implement to deflect or break can be measured by a piezoelectric element; dynamometer or accelerometer.

Deflection of the cutting implement which results in a positional error of the cutting surface and is proportional to the force on the cutting implement so can be used to assess this condition can be measured using an internal optical transducer; piezoelectric element; strain gauge; or capacitor.

Acoustic emission which is indicative breakage or chipping of the cutting implement can be measured by a piezoelectric element or microphone.

Resistance of an electrical circuit located on the cutting surface is indicative of cutting implement wear.

Neural networks can be used to combine data from one or more sensors, which measure more than one parameter in total to interpret and interpolate when a tool breakage is likely to occur and stop the process or change the tool prior to this event to prevent damage to the work piece/machine in the event of a breakage.

Some of the conditions or parameters can be manipulated or dynamically altered during the machining process. For example, temperature of the cutting implement or work piece can be controlled by internal or external cryogenic cooling by, say liquid nitrogen. The feed rate of the coolant may be altered during the machining process to maintain temperature conditions.

Vibration, chatter or work piece instability, for example to mitigate the effects of resonant frequencies of the cutting implement, can be controlled by altering a physical characteristic of the cutting implement which changes the resonant frequency or, changing spindle speed which changes the frequency of the vibration so, moves the cutting implement out of a resonant frequency zone. Vibration or imbalance of the spindle or spindle bearing can be controlled by the manipulation of servo drive weighting; or piezoelectric elements.

The provision of power to the cutting implement enables extra functionality of the cutting implement, for example to allow it to move with respect to the spindle. Such functionality is advantageous in a number of circumstances including, the machining of valve seats, facing heads and the use of single point boring heads. Another application for independently moveable cutting implements is as intelligent depth machining implements. Independent movement of the cutting implement enables accurate hole depth and diameter measurements (smaller or commensurate to the travel of the cutting implement with respect to the spindle).

The invention also enables the provision of rotating cutting implements. This can either be at high speed so as to assist in the machining process or slow speed, for example with circular cutting surfaces, where the cutting implement is rotated as the cutting surface wears which extends the length of time the machining process can continue before a tool change operation is required. The rotation can be continuous—for circular surfaces—or, discrete—for triangularly shaped cutting surfaces—for example. In the case of cutting surfaces having three or more sides, an actuator, for example a piezoelectric element can be provided. Here, automatic cutting insert indexing may be provided. Whereby the piezoelectric element lifts the insert, enabling rotation and subsequent relocation of the insert into the cutting position at predetermined time intervals through the machining process.

It is also possible to provide automatic tool replacement without the need for manual intervention or even a tool changer. In one example, a stack of cutting surfaces or inserts is provided within the cutting implement and when the one in use is worn, it is mechanically ejected from the cutting implement by, for example, a piezoelectric element or piston provided, allowing a new cutting surface to be exposed to the work piece. Alternatively, a segmented cutting insert is provided whereby, when the segment in use wears out, the weaker joint between it and the adjacent segment is broken, by for example lowering the segmented cutting insert until the joint is level with the spindle face and knocking the cutting insert against a surface to snap the joint thereby letting the next segment be presented to the work piece.

The invention additionally enables the use of an internal minimum quantity lubrication system. A reservoir of coolant is provided adjacent or integral with the cutting implement and the lubricant is channeled to be released at the cutting surface. Alternatively or additionally, the coolant can be pumped through the tool shank. Compressed or chilled air may instead be provided through the tool shank to exit at the cutting surface.

The cutting parameters include controller based parameters such as spindle speed; feed rate; depth of cut; acceleration; and, sensor based parameters such as cutting implement position; cutting implement geometry; cutting surface geometry. All of these parameters can be monitored by the NC or external interface. Additionally, sensor based parameters can be monitored and adapted independently of the NC i.e. internally to the cutting implement using MEMS or a partially or fully integrated cutting implement based interface.

In one example the conditions sensed may be cutting force. The force can be measured at or near the cutting implement in a number of ways e.g. torque on the machine tool's spindle, stress/strain in the cutting implement or workpiece, tool holder, or other machine part, or changes in velocity at the cutting implement.

The deflection of the cutting implement due to a certain force can be determined e.g. by taking a cut and measuring the cutting force against effective cut depth, or by pre-calibration of the cutting implement off-line.

If a deflection per cutting force value is known then, when the cutting force is sensed during work production and input at the NC, the cutting program can be modified to alter the cutting path of a cutting implement and hence produce a more accurate cut. Cutting implement deflection can be used also to improve cutting efficiency if the cutting implement path is altered e.g. the maximum cutting force can be applied continually where appropriate. Alternatively reduced speed, feed and/or depth of cut can be applied to prolong cutting implement life.

FIG. 3 shows a cutting implement 240 which has cutting surfaces 248 with integral strain gauges 250. Power is provided to the strain gauges 250 and the signal taken from the strain gauges via an electrical path 260 which terminates 262 at contacts 232 in the shank 230, which when the cutting implement is inserted in a tool shank or tool block of a machine tool, contacts complimentary contacts (FIG. 1) at the spindle.

An integral strain gauge can indicate deflection and force on the cutting implement. High deflection means that the machining process may be out of tolerance and the force can be used to judge if the optimal cutting speed is being used. Additionally, the weight, balancing or velocity of the cutting surface or tool holder is monitored by an accelerometer and when a significant change occurs, this is fed-back to the machine controller as such a change is indicative of damage to the cutting surface.

Advantageously, the integral sensors can be provided as a smart tooling system whereby, the sensors do not necessarily feedback to a machine controller in order to effect a change in cutting conditions. In this embodiment, the sensors are part of a mini-circuit within the cutting surface or tool holder which includes, for example a micro-electromechanical system or MEMS. The mini-circuit may include all or part of the functionality of an external interface. Any sensor based parameters are changeable internally by using an integrated interface or MEMS. Any controller based parameters i.e. external parameters are adapted using the NC or external interface.

Various features of the cutting surface or tool holder can be monitored. For example, if an integral piezoelectric element is used and the force on the cutting implement is too high, the micro-circuit causes a change to the piezoelectric element to reduce the cutting depth. The cutting surfaces could be rotated or pulsed to improve evenness of wear and increase machining speed. Depending on the angle of the face of the workpiece being machined, a piezoelectric element could be used to change the rake angle and/or clearance angle or the jacking of flutes of the cutting surface to again optimise the machining process.

The cutting implement may, advantageously be provided with actuators which are responsive to signals from the machine controller and/or smart tooling. For example, if the force or deflection of the cutting implement as measured by a strain gauge or an optical transducer is out of tolerance, then the an actuator, such as a piezoelectric device of the cutting implement, alters the diameter of the cutting implement to effect a change to the cutting force/deflection and move this parameter back into tolerance. Also, if a sensor is provided which can locate the workpiece surface with respect to the cutting implement position, deviations from the expected location can be accounted for by changing the diameter of the cutting implement. Such an actuator is also useful when using a broacher on a grinding machine. As rather than having a broacher of variable diameter along its' length, a shorter broacher may be used and expanded using the aforementioned actuators during the grinding process. This type of cutting implement can be used instead of expensive currently available adjustable form tools.

Another type of adaptive tool is one of variable length. For example when a deep bore must be machined, traditionally an appropriately sized tool is used however, as the length of the tool increases, the more unstable the tool becomes and more difficulties in controlling the accuracy of the cut are encountered. Again, the provision of power to the spindle enables a variable length of cutting implement to be provided. Thus, at the start of drilling the bore, a short, stiff tool is used. This initial cut then guides the gradually lengthening tool this enables a faster drilling process and a more accurate bore to be drilled.

In another example the NC program can be modified such that a signal is sent to the cutting implement when predefined conditions are sensed. In a specific example, the cutting implement is equipped with piezo-elements at the or each cutting point which can be exited. The degree of excitation can be controlled by the NC. Thus if, for example, significant material removal is required then the degree of excitation can be increased. Alternatively if vibration is sensed at the cutting implement the excitation can be used to cancel-out that vibration. Alternatively the effective position of the cutting implement can be altered by varying the excitation of the cutting implement.

More generally any feedback from the NC which can alter the work producing process is possible. In the embodiment shown in the drawing this feedback would be sent via the path described above, and would e.g. alter the mode of cutting or change other work producing conditions. In particular, the feedback can be used to correct for machine tool inaccuracies.

The invention is applicable to lathe type machines using a single cutting implement as well as milling type machines which generally use rotating cutters with multiple teeth.

The invention has been described with reference to a machine tool cutting material, but any type of machine tool workpiece production is possible using the invention e.g. grinding, laser material removal and electrical discharge machining.

1. A machine tool control method employing a machine tool for carrying out a work producing process having a cutting implement for machining a workpiece according to the work producing process the cutting implement comprising a first part having a shank and a second part having a cutting surface; a sensor device provided on the second part of the cutting implement for sensing at least one condition of the work producing process; and a machine controller, the method comprising in any suitable order the steps of:
operating the machine under the control of the machine controller to cause a work producing process to commence;
sensing at least one condition of the work producing process; and
adapting cutting parameters during the work producing process in accordance with the sensed condition.

2. A method according to claim 1 wherein, the cutting implement is changeable during the work producing process.

3. A method according to claim 1 wherein, the work producing process comprises a single cutting operation.

4. A method according to claim 1, the second part of the cutting implement further includes a tool holder.

5. A method according claim 1 wherein, the cutting parameter is controller based or sensor based.

6. A method according in claim 5 wherein, sensor based parameters are adapted independently of the machine controller.

7. A method according to claim 1 wherein, the cutting parameter includes any of: spindle speed; feed rate; depth of cut; acceleration; cutting implement position; cutting implement geometry; cutting surface geometry.

8. A method according to claim 1 wherein, the machine tool includes a feedback loop between the machine controller and the cutting implement enabling adaptation of the work producing process.

9. A method according to claim 8 wherein, the at least one sensed condition is communicated to the controller in real time.

10. A method according to claim 1 wherein, the sensor is a strain gauge; thermistor; thermocouple; piezoelectric element; capacitor; magnetostrictive element; electrostrictive element; an optical transducer; electrical circuit; or an accelerometer.

11. A machine tool according to claim 1 wherein, the sensor is integral to the second part of the cutting implement.

12. A machine tool according to claim 11 wherein, the sensor is provided on the cutting surface and wherein, the cutting surface is replaceable.

13. A method according to claim 1 wherein, the sensed conditions include cutting forces.

14. A machine tool controller for use with the method of claim 1.

15. A machine tool controller operable according to the following method steps:
loading a workpiece producing process program;
running the program to control the machine including rotating a spindle at a preselected rotational speed and causing relative movement of a preselected vector quantity between the spindle of the machine tool and a workpiece or cutting implement;
providing feedback to the controller relating to work producing conditions;
characterised by the step of:
altering the rotational speed of the spindle or the vector quantity of the spindle relative to the workpiece or cutting implement during the work producing process and in accordance with the conditions communicated to the controller.

16. A method according to claim 15 capable of adaptive control wherein, at least one input indicative of the said conditions are continually monitored whilst control of the work producing process is underway and the work producing process is updated substantially in real time when required.

17. A method according to claim 15 wherein, the at least one condition includes one or more of the following:
vibration amplitude, frequency or variations thereof of either the cutting implement, work or parts of the machine;
temperature of the cutting implement, workpiece chips/swarf, or workpiece;
torque or forces exerted on the spindle or individual teeth of a cutter;
stress or strain or variations thereof on part of the machine, the cutter or the workpiece;
changes in amplitude or frequency of an excited cutting implement;
changes in capacitance, electrical resistance, magnetostrictive or electrostrictive properties of the cutting implement;
deflection of the cutting implement; and
errors in machine tool performance.

18. A method according to claim 15 wherein, the at least one condition is communicated to the machine controller via a path which runs from the cutting implement through the spindle of the machine to the controller.

19. A method according to claim 18 wherein, the path includes contacts at the spindle at the interface between the cutting implement and the machine tool and a rotatable link between the spindle and the fixed part of the machine.

20. A method according to claim 15 wherein, at least one condition is sensed using a sensor provided on the cutting implement at the cutting surface or on the tool holder.

21. A method according to claim 20 wherein, the cutting implement is rotatable and the sensing of the conditions may take place whilst the cutting implement is rotating and/or cutting.
